(19) United States
(12) Patent Application Publication
(10) Pub. No.: US 2014/0177506 A1
(43) Pub. Date: Jun. 26, 2014

(54) METHOD AND APPARATUS FOR IDENTIFYING A MULTIMEDIA BROADCAST/MULTICAST SERVICE (MBMS) AREA IN A WIRELESS COMMUNICATION SYSTEM

(71) Applicant: MOTOROLA SOLUTIONS, INC., Schaumburg, IL (US)

(72) Inventors: Michael F. Korus, Eden Prairie, MN (US); Anatoly Agulnik, Deerfield, IL (US); Peter M. Drozt, Prairie Grove, IL (US)

(73) Assignee: MOTOROLA SOLUTIONS, INC., SCHAUMBURG, IL (US)

(21) Appl. No.: 13/723,180

(22) Filed: Dec. 20, 2012

(51) Int. Cl. H04W 4/06

(52) U.S. Cl. CPC H04W 4/06
USPC 370/312

(57) ABSTRACT

A method and eMBMS-enabled infrastructure device are disclosed that provide an updated mechanism for a client, or user equipment (UE), to report its location such that an eMBMS-enabled application desiring eMBMS location information can uniquely identify the MBSFN in which the UE is located. The method and eMBMS-enabled infrastructure device identify an eMBMS area associated with a user equipment UE by receiving, from the UE, a Multicast Broadcast Single Frequency Network (MBSFN) Area update message from a user equipment, wherein the MBSFN Area update message uniquely identifies an MBSFN Area and includes an extension identifier derived from one or more of a cell identifier, an eNodeB identifier, an identifier of a group of cells, a service identifier, a tracking area identifier, and a paging area identifier, and optionally further may include an MBSFN AreaID, and determining an MBSFN Area serving the user equipment based on the received eMBMS area identifier.

### FIELD OF THE INVENTION

The present invention relates generally to wireless communication systems, and, in particular, to Multimedia Broadcast/Multicast Service communication systems.

### BACKGROUND OF THE INVENTION

Starting in Release 9 of the Third Generation Partnership Project (3GPP) standards, evolved Multimedia Broadcast/Multicast Service (eMBMS) will be supported. With eMBMS, cells are grouped together into simulcast areas to simultaneously transmit identical information. These simulcast areas are called Multicast Broadcast Single Frequency Network (MBSFN) Areas. An MBSFN Area is identified on the 3GPP LTE (Long Term Evolution) air interface by an 8-bit field called an MBSFN-AreaID, and as a result there are only 256 possible MBSFN-AreaIDs (that is, the values from 0 to 255). All eNodeB cells in a MBSFN Area transmit the MBSFN-AreaID in a System Information Block 13 (SIB-13). Further, the 8-bit MBSFN-AreaID is a Public Land Mobile Network (PLMN) wide identifier (ID), and therefore there are only 256 such area ID values available for the entire PLMN network.

On Jan. 9, 2011, the Federal Communications Commission issued an order mandating the use of a single PLMN-ID for the nationwide 700 MHz public safety broadband network. However, by using a single, nationwide PLMN-ID, the 256 MBSFN ID space is insufficient to uniquely identify MSFBNs within the PLMN.

eMBMS is considered an important technology for providing mission critical Push-to-Talk (PTT) service for public safety, particularly important for densely populated talkgroups. An architecture of mission critical group services takes advantage of the underlying 3GPP eMBMS service. In a mission critical group services architecture, when a user equipment (UE) learns of a change in its MBSFN-AreaID, the UE reports the new MBSFN-AreaID(s) to a group services server to inform the server which MBSFNs to include in PTT calls (much like in Land Mobile Radio (LMR) systems where the ZC tracks radios to sites). However, the MBSFN ID space in the nationwide network is limited to 256 values, which results in a severe shortage of MBSFN-Area IDs for identifying broadcast areas as planned in mission critical group services (for example, there are not enough MBSFN IDs to cover even 10% of the 3,134 counties in the U.S.). Thus, as applied to a mission critical group service, when a UE reports its MBSFN-AreaID to the group services server, the MBSFN-AreaID reported will become an ambiguous value since multiple MBSFN areas throughout the US will use the exact same MBSFN-AreaID. One may note that 3GPP did not intend the MBSFN-AreaID to be unique within a PLMN, just unique with respect to neighboring MBSFNs.

Therefore, there is a need for an updated mechanism for a client, or UE, to report its MBSFN Area such that an eMBMS-enabled application desiring eMBMS area information can uniquely identify the MBSFN Area serving the UE.

### BRIEF DESCRIPTION OF THE DRAWINGS

FIG. 1 is a block diagram of a Multimedia Broadcast/Multicast Service (MBMS) communication system in accordance with an embodiment of the present invention.

FIG. 2 is a block diagram of a user equipment (UE) of the communication system of FIG. 1 in accordance with an embodiment of the present invention.

FIG. 3 is a block diagram of an eNodeB of the communication system of FIG. 1 in accordance with an embodiment of the present invention.

FIG. 4 is a block diagram of an Evolved Packet Core (EPC) element of the communication system of FIG. 1 in accordance with an embodiment of the present invention.

FIG. 5 is a block diagram of a Group Application Server of the communication system of FIG. 1 in accordance with an embodiment of the present invention.

FIG. 6 is a table eMBMS Area Database depicting an exemplary mapping of eNodeB/cell identifiers to MBMS service area identifiers, such as a list of Service Area Identifiers (SAIs), and to Multicast Broadcast Single Freqeuncy Networks (MBSFNs) in accordance with an embodiment of the present invention.

FIG. 7 is a logic flow diagram illustrating a method performed by the UE of FIG. 1 to identify, to a Group Application Server, an eMBMS service area of the UE in accordance with an embodiment of the present invention.

FIG. 8 is a block diagram of an exemplary eMBMS area identifier in accordance with various embodiments of the present invention.

FIG. 9 is a logic flow diagram illustrating a method performed by the Group Application Server of FIG. 1 to update an eMBMS Area Database in response to receiving eMBMS service area information from a user equipment in accordance with an embodiment of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and an apparatus that provide an updated mechanism for a client, or UE, to report its MBSFN Area such that an eMBMS-enabled application desiring eMBMS location information can uniquely identify the MBSFN Area serving the UE, a method and evolved Multimedia Broadcast/Multicast Service (eMBMS)-enabled infrastructure device are provided that identify an eMBMS area associated with a user equipment UE by receiving, from the UE, a Multicast Broadcast Single Frequency Network (MBSFN) Area update message from a user equipment, wherein the MBSFN Area update message includes an eMBMS area identifier that uniquely identifies an MBSFN Area and includes an extension identifier derived from one or more of a cell identifier, an eNodeB identifier, an identifier of a group of cells, a service identifier, a tracking area identifier, and a paging area identifier, and optionally further may include an MBSFN AreaID, and determining an MBSFN Area serving the user equipment based on the received eMBMS area identifier.

Generally, an embodiment of the present invention encompasses a method for providing evolved Multimedia Broadcast/Multicast Service (eMBMS) area information in a Multimedia Broadcast/Multicast Service (MBMS) communication system. The method includes receiving a Multicast Broadcast Single Frequency Network (MBSFN) Area update message from a user equipment, wherein the MBSFN Area update message includes an eMBMS area identifier that uniquely identifies an MBSFN Area and comprises an extension identifier derived from one or more of a cell identifier, an eNodeB identifier, an identifier of a group of cells, a service identifier, a tracking area identifier, and a paging area identifier, and determining an MBSFN Area serving the user equipment based on the received eMBMS area identifier.

Another embodiment of the present invention encompasses a method for providing eMBMS area information in an MBMS communication system. The method includes detecting, by a user equipment (UE), a cell change from an old cell to a new cell, and determining, by the UE, whether the old cell supports MBMS and whether the new cell supports MBMS. The method further comprises, in response to determining that the new cell supports MBMS, determining whether the new cell is associated with a different MBSFN-AreaID than an MBSFN-AreaID associated with the old cell and, when the new cell is associated with a different MBSFN-AreaID than an MBSFN-AreaID associated with the old cell, sending a MBSFN Area update message that includes an eMBMS area identifier comprising a MBSFN-AreaID and an extension identifier derived from one or more of a cell identifier, an eNodeB identifier, an identifier of a group of cells, a service identifier, a tracking area identifier, and a paging area identifier.

Yet another embodiment of the present invention encompasses an eMBMS-enabled infrastructure device comprising a processor that is configured to receive an MBSFN Area update message from a user equipment, wherein the MBSFN Area update message includes an eMBMS area identifier that uniquely identifies an MBSFN Area and comprises an extension identifier derived from one or more of a cell identifier, an eNodeB identifier, an identifier of a group of cells, a service identifier, a tracking area identifier, and a paging area identifier, and determine an MBSFN Area serving the user equipment based on the received eMBMS area identifier.

Still another embodiment of the present invention encompasses an eMBMS-enabled user equipment comprising a processor that is configured to detect a cell change from an old cell to a new cell and determine whether the old cell supports MBMS and whether the new cell supports MBMS. The processor further is configured to, in response to determining that the new cell supports MBMS, determine whether the new cell is associated with a different MBSFN-AreaID than an MBSFN-AreaID associated with the old cell and, when the new cell is associated with a different MBSFN-AreaID than an MBSFN-AreaID associated with the old cell, send an MBSFN Area update that includes an eMBMS area identifier comprising a MBSFN-AreaID and an extension identifier derived from one or more of a cell identifier, an eNodeB identifier, an identifier of a group of cells, a service identifier, a tracking area identifier, and a paging area identifier.

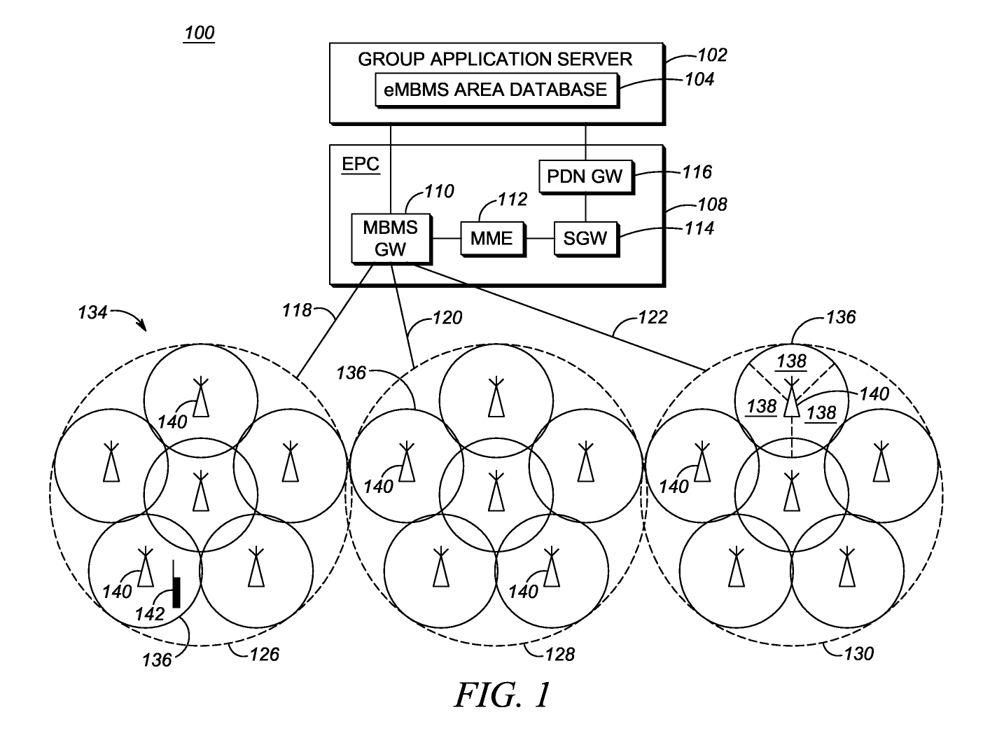

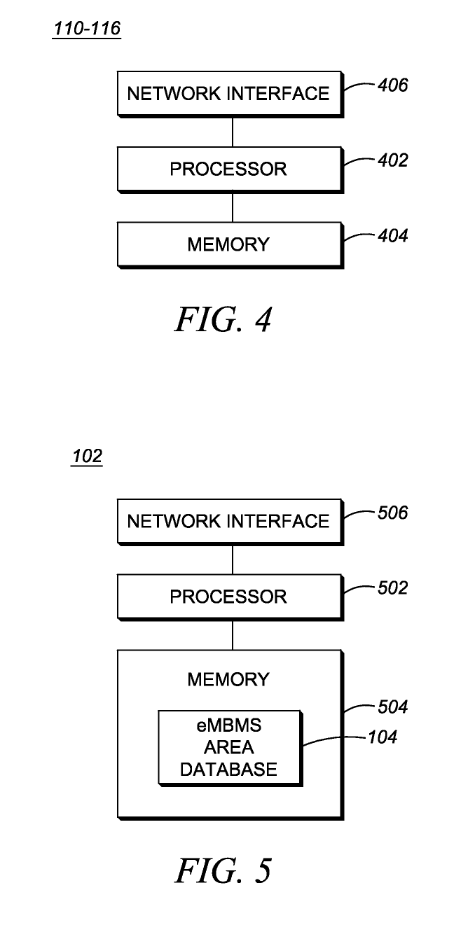

The present invention may be more fully described with reference to FIGS. 1-9. FIG. 1 is a block diagram of a wireless communication system 100 in accordance with an embodiment of the present invention. Communication system 100 includes an eMBMS-enabled, application level, infrastructure device 102 coupled to an LTE Evolved Packet Core (EPC) 108. EPC 108 includes a Mobility Management Entity (MME) 112, an MBMS Gateway (MBMS GW) 110 and a Serving Gateway (SGW) 114 that are each connected to the MME, and a Packet Data Network Gateway (PDN GW) 116 connected to the SGW. EPC 108 may include other elements of an LTE EPC as is know in the art, which elements are not illustrated in FIG. 1 for ease of illustration, such as a Broadcast Multicast Service Center (BM-SC) which could be located within the EPC or within the application level, for example, as infrastructure device 102. Communication system 100 further includes a radio access network (RAN) 134, in this case an LTE Evolved Universal Terrestrial Radio Access Network (E-UTRAN), that includes multiple eNodeBs 140, and a user equipment (UE) 142. In general, the EPC and the E-UTRAN are referred to collectively as the LTE system. The elements of communication system 100 and the interfaces between them are further described below.

eMBMS-enabled application level infrastructure device 102 facilitates transport of media (for example, voice, data, video, etc.) from one or more source applications to one or more destination devices (such as members affiliated with a communication group, such as a talkgroup) over the LTE system. As such, the infrastructure device may be, for example, a computer-aided dispatch (CAD) server, a media server, a Push-to-Talk (PTT) call controller, a Broadcast Multicast Service Center (BM-SC), a Group Application Server, and so on and, for ease of reference, is referred to herein as Group Application Server 102. In one illustrative embodiment, Group Application Server 102 is an application server in a packet data network providing application layer services to a UE, such as UE 142, connected to E-UTRAN 134 that are authorized and have the capabilities to use these services. In this instance, Group Application Server 102 provides PTT services to the UE. Other services may include, for example, distribution of video, distribution of images, distribution of data, etc.

In one illustrative embodiment, Group Application Server 102 communicates with a UE, such as UE 142, using control signaling described in OMA-TS-PoC_ControlPlane-V1_{—}0_{—}3-20090922-A and OMA TS PoC UserPlane-V1_{—}0_{—}3-20090922-A (and any subsequent revisions, hereinafter referred to the OMA PoC TS), which defines the procedures of a Push-to-Talk Over Cellular (PoC) Client (e.g., the UE) and a PoC Server (e.g., the Group Application Server 102). The OMA PoC TS references Session Initiation Protocol (SIP) (for example as described in Internet Engineering Task Force (IETF) Request for Comments (RFC) 3261 dated June 2002, and any subsequent revisions) as an enabling control protocol for requests for initiating and ending media transmissions and other control signaling. Therefore, some aspects of the present teachings are described by reference to protocols and message structures described in the OMA PoC TS. However, the present teachings are not limited to the use of OMA PoC but can be extended to other protocols both standard and proprietary. Group Application Server 102 further includes an eMBMS Area Database 104 that maintains an identifier of an eMBMS area, for example, a Multicast-Broadcast Single Frequency Network (MBSFN) area, of each UE, such as UE 142, served by the Group Application Server, that is, a location of the UE with respect to a provision of eMBMS services to the UE.

EPC 108 is an all-IP core network that provides mobile core functionality that, in previous mobile generations (2G, 3G), has been realized through two separate sub-domains: circuit-switched (CS) for voice and packet-switched (PS) for data. EPC 108 enables the above-mentioned all IP end-to-end delivery of media: from mobile handsets and other user equipment with embedded IP capabilities, over IP-based eNodeBs, across the EPC and throughout the application domain, IMS (IP Multimedia Subsystem) and non-IMS.

UE 142 also may be referred to in the art as a subscriber unit, a subscriber station, an access device, an access terminal, a mobile station, a mobile device, a user terminal, and the like. UE 142 can be any type of communication device, such as a data terminal used in a vehicle, a radio, a cell phone, a mobile data terminal, a Personal Digital Assistants (PDAs), a laptop computer, a two-way radio, and any other device capable of operating in a wired or wireless environment and that can be used by a user in the system.

The elements of E-UTRAN 134 and of EPC 108, Group Application Server 102, and UE 142 implement protocols and signaling in compliance with Third Generation Partnership Project (3GPP) Technical Specifications (TSs), including, but not limited to, 3GPP TSs 26.346 and 23.246, which describe aspects of 3GPP MBMS. Further, the terms LTE communication system, LTE system, and Evolved Packet System (EPS) are used interchangeably herein and are each defined as being inclusive of the E-UTRAN 134 and the EPC 108 but not inclusive of the Group Application Server 102 or UE 142. Moreover, while only a limited number of EPC and E-UTRAN elements, one UE, and one Group Application Server are shown in FIG. 1, more such elements may be included in an actual system implementation. Also, the E-UTRAN can be any type of access network, including any 3G, for example, UMTS, or 4G, for example, WiMAX, access network or a WiFi access network.

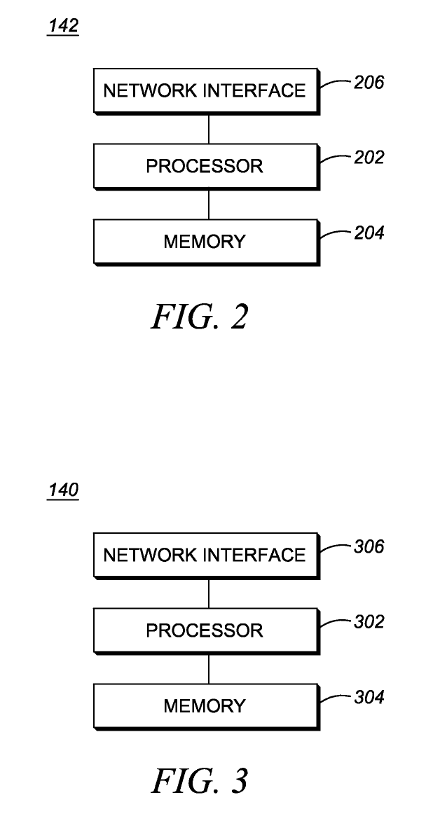

Referring now to FIGS. 2-5, block diagrams are provided of UE 142, eNodeBs 140, EPC elements 110-116, and Group Application Server 102 in accordance with an embodiment of the present invention. Each of UE 142, eNodeBs 140, EPC elements 110-116, and Group Application Server 102 includes a respective processor 202, 302, 402, and 502 such as one or more microprocessors, microcontrollers, digital signal processors (DSPs), combinations thereof or such other devices known to those having ordinary skill in the art. The particular operations/functions of processors 202, 302, 402, and 502 and thus of UE 142, eNodeBs 140, EPC elements 110-116, and Group Application Server 102, is determined by an execution of software instructions and routines that are stored in a respective at least one memory device 204, 304, 404, and 504 associated with the processor, such as random access memory (RAM), dynamic random access memory (DRAM), and/or read only memory (ROM) or equivalents thereof, that store data and programs that may be executed by the corresponding processor.

Each eNodeB 140 maintains, in its at least one memory device 304, one or more identifiers of the eNodeB and or a cell served by the eNode B, for example, an eNodeB identifier (eNodeB ID), a cell identifier (Cell ID), an E-UTRAN Cell ID (ECI), or an E-UTRAN Cell Global Identifier (ECGI). As is known in the art, the eNodeB regularly broadcasts such one or more identifiers in overhead messages, so that a UE residing in a coverage area served by the eNodeB can determine its serving eNodeB and/or associate measurements with an eNodeB sourcing the signal. Further, each eNodeB 140 maintains, in the at least one memory device 304 of the eNodeB, a mapping of the cell and/or eNodeB identifiers to MBMS-SAIs, which mapping is pre-programmed into the eNodeB.

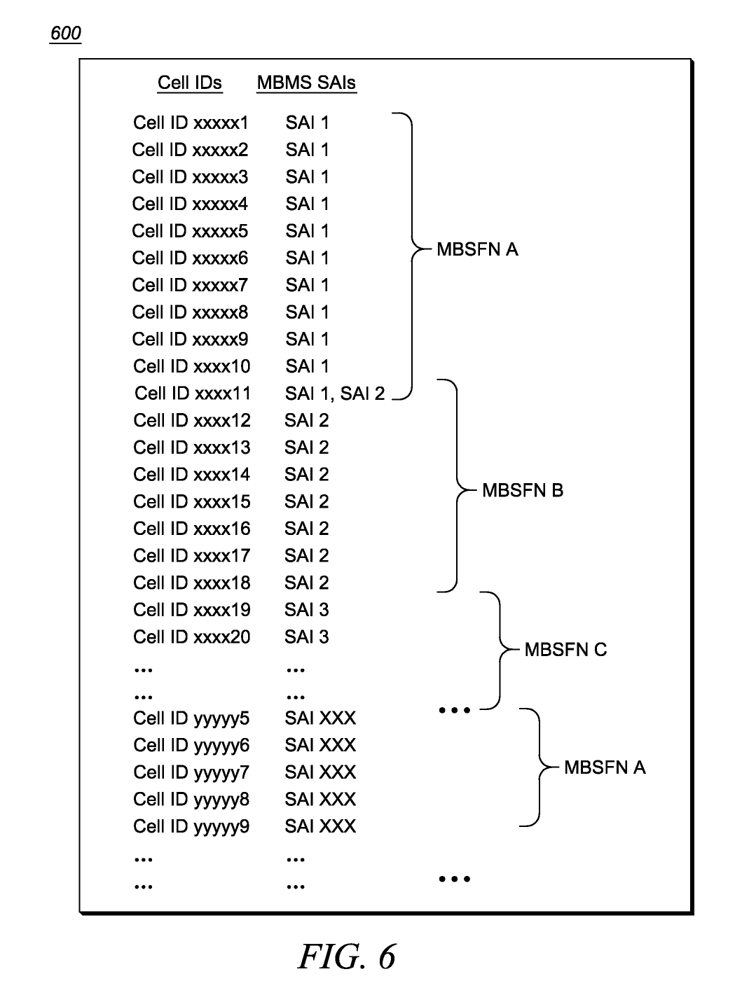

Group Application Server 102 maintains, in at least one memory device 504, eMBMS Area Database 104. eMBMS Area Database 104 maintains a mapping of, for example and as is described in greater detail below with reference to FIG. 6, cell and/or eNodeB identifiers, and/or MBMS-SAIs (MBMS Service Area Identifiers), to MBSFN Area identifiers (MBSFN AreaIDs). This mapping may be established, and programmed into the eMBMS Area Database, during system configuration, when cells are grouped together into subgroups and are identified by MBMS SAIs. MBMS SAIs are unique per Public Land Mobile Network (PLMN) and an eMBMS Service Area, for ease of discussion also referred to herein as an MBSFN Area, may include one or more MBMS SAIs. One may note that a cell can belong to more than one SAI, and thus a cell can belong to more than one MBSFN. In fact, the 3GPP LTE standards allows a cell to participate in up to eight different MBSFNs. Since a cell can belong to more than one MBSFN, knowledge of a UE's cell ID alone does not uniquely map the UE to a MBSFN. eMBMS Area Database 104 further maintains a mapping between each UE served by Group Application Server 102 and an eMBMS service area (for example, an MBSFN-AreaID) associated with the UE, for example, as depicted in in table 600.

Further, access to RAN-specific eMBMS configuration/provisioning (for example, the cell/eNodeB-to-MBMS SAI mappings configured in eNodeBs 140) is assumed to be available to Group Application Server 102 and/or can be pre-provisioned into the Group Application Server. In such a case, eMBMS Area Database 104 may be configured with one or more tables mapping eNodeB/cell identifiers to one or more of identifiers of a group of cells within a PLMN, such as service area identifiers (SAIs), a service identifier associated with an MBMS service to which the UE has subscribed, such as a Temporary Mobile Group Identity (TMGI), and a tracking, or paging, area identifier associated with the cell where the UE is located, and further mapping the eNodeB/cell identifiers to MBSFN-AreaIDs. For example, FIG. 6 depicts an exemplary table 600 wherein each row of the table comprises a mapping of an eNodeB/cell identifier to an SAI and to an MBSFN-AreaID. From another perspective, each row of table 600 comprises an extended MBSFN identifier, wherein the extended MBSFN identifier comprises a cell identifier (Cell ID), a Service Area Identifier (SAI), and an MBSFN-AreaID associated with a cell. Such a table may be a national table or a per-region table, depending on the system (for example, FirstNet) deployment.

UE 142 further maintains, in at least one memory device 204, an identifier of the cell or eNodeB currently serving the UE, and an identifier of an eMBMS service area, for example, an MBSFN-AreaID, currently serving the UE. The UE may obtain such identifiers from system messages monitored by the UE, which identifiers then are stored by the UE in at least one memory device 204.

Each of UE 142, eNodeBs 140, EPC elements 110-116, and Group Application Server 102 further includes a respective one or more network interfaces (one shown) 206, 306, 406, and 506 that are operatively coupled to the corresponding processor and that are used for passing signaling, also referred to herein as messaging, for example, messages, packets, datagrams, frames, superframes, and the like, between the elements of communication system 100. The implementation of the network interface in any particular element depends on the particular type of network, that is, wired and/or wireless, to which the element is connected. Where the communication system supports wireless communications, the network interfaces 206, 306, 406, 506 include elements including processing, modulating, and transceiver elements that are operable in accordance with any one or more standard or proprietary wireless over-the-air interfaces, wherein some of the functionality of the processing, modulating, and transceiver elements may be performed by means of the processing device through programmed logic such as software applications or firmware stored on the memory device of the system element or through hardware.

The embodiments of the present invention preferably are implemented within UE 142, eNodeBs 140, EPC elements 110-116, and Group Application Server 102, and more particularly with or in software programs and instructions stored in the respective at least one memory device 204, 304, 404, 504 and executed by respective processors 202, 302, 402, 502 associated with the of the UE, eNodeBs, EPC elements, and Group Application Server. However, one of ordinary skill in the art realizes that the embodiments of the present invention alternatively may be implemented in hardware, for example, integrated circuits (ICs), application specific integrated circuits (ASICs), and the like, such as ASICs implemented in one or more of UE 142, eNodeBs 140, EPC elements 110-116, and Group Application Server 102. Based on the present disclosure, one skilled in the art will be readily capable of producing and implementing such software and/or hardware without undo experimentation.

Referring again to FIG. 1, MBMS GW 110 is an entry point in the LTE system from Group Application Server 102, and the MBMS GW distributes MBMS traffic to all eNodeBs within eMBMS service areas. eMBMS may use a Single Frequency Network (SFN) transmission, also referred to as MBSFN. In MBSFN, or more particularly in a given MBSFN geographic area, the eMBMS transmission happens from a time-synchronized set of eNodeBs 140 in the service area, using the same resource blocks. IP multicast can be used for distributing the traffic from the MBMS GW 110 to the different eNodeBs. Moreover, in an embodiment, media is delivered from the LTE EPC (via the MBMS GW 110) to the eNodeBs 140 in each MBSFN Area of E-UTRAN 134 using Protocol-Independent Multicast source-specific multicast (PIM-SSM), as illustrated by links 118, 120, and 122.

As described in the 3GPP TSs, a radio access network (RAN) such as E-UTRAN 134 can be partitioned into one or more eMBMS service areas, with each eMBMS service area covering a particular geographical area in which eMBMS transmissions to the UE can occur. An MBMS service area comprises one or more MBSFN Areas each identified by a MBSFN-AreaID. Further, each MBSFN Area generally includes multiple cells, wherein a cell is defined as being inclusive of a single eNodeB's coverage area or a portion of an eNodeB's coverage area and can be identified by a cell identifier. As such, the present teachings also apply to a logical partitioning of E-UTRAN 134 where there is a one-to-many correspondence between the eMBMS service area and MBSFN Area.

SGW 114 routes and forwards user point-to-point data packets, while also acting as the mobility anchor for the user plane during inter-eNodeB handovers and as the anchor for mobility between LTE and other 3GPP technologies. There are also links between SGW 114 and the eNodeBs for transporting media that are not shown in FIG. 1 for the purpose of simplifying the diagram. PDN GW 116 provides connectivity to the UE to external packet data networks (PDNs) by being the point of exit and entry of traffic for the UE from EPC 108. A UE may have simultaneous connectivity with more than one PDN GW for accessing multiple packet data networks (PDNs). PDN GW 116 performs policy enforcement, packet filtering for each user, charging support, lawful interception and packet screening using policy and charging rules provided by a Policy and Charging Rules Function (PCRF), which is not shown. Another key role of the PDN GW 116 is to act as the anchor for mobility between 3GPP and non-3GPP technologies such as WiMAX and 3GPP2 (CDMA 1X and EvDO).

E-UTRAN 134 comprises multiple cells each served by an eNodeB. As shown in FIG. 1, E-UTRAN 134 includes multiple eNodeBs 140, each having roughly the same coverage area 136 and that each comprises three cells 138. The eNodeBs serve as the intermediate infrastructure device between a UE, such as UE 142, and EPC 108 and a point of access for the UE to assigned or allocated bearers. Each cell represents a geographic coverage area that provides the wireless resources termed herein as bearers for carrying data (or SDFs) for UE connected to the E-UTRAN. Although in this illustrative implementation, each eNodeB coverage area comprises three cells, the number of cells per eNodeB coverage area may be more than three and as few as one.

Further, E-UTRAN 134 comprises multiple (in this example three) MBSFN Areas 126, 128, and 130, each having a same number (for example, six as depicted in FIG. 1) of eNodeB coverage areas and corresponding number of cells (18). As shown in FIG. 1, the MBSFN Areas may partially overlay. However, at least some (or all) of the MBSFN Areas may have mutually exclusive geographically boundaries.

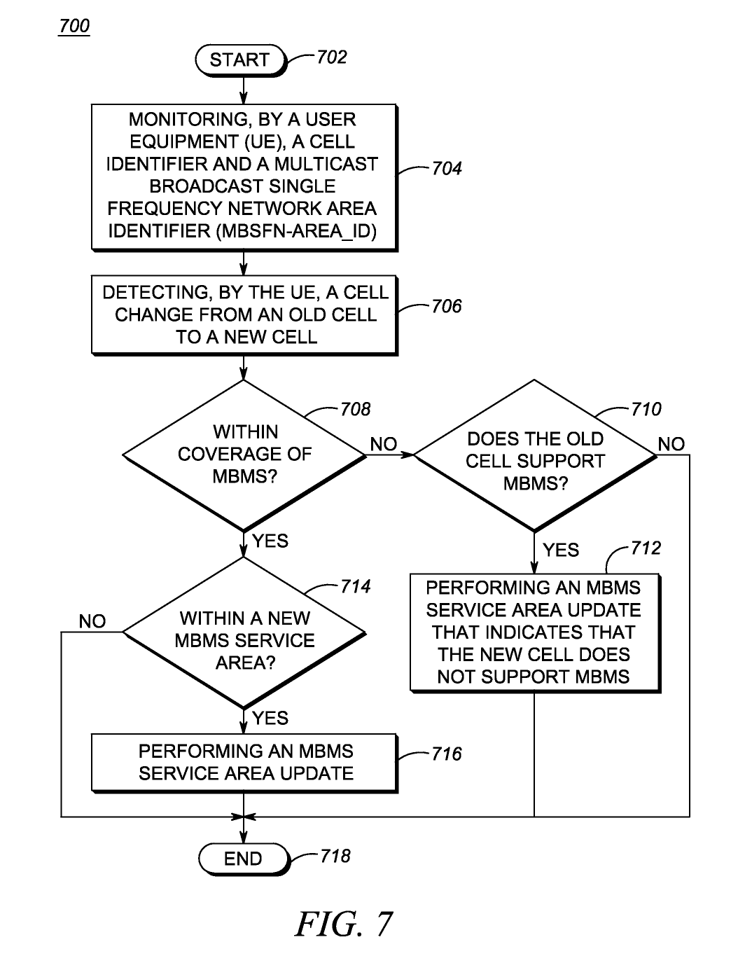

Referring now to FIG. 7, a logic flow diagram 700 is provided that illustrates a method performed by a UE, such as UE 142, to identify, to Group Application Server 102, an MBSFN Area of the UE in accordance with an embodiment of the present invention. In short, the UE determines one or more eMBMS service areas in which the UE is currently located and then identifies each eMBMS service area to the Group Application Server 102 by sending one or more MBSFN Area identifiers. Logic flow diagram 700 begins (702) when the UE, that is, UE 142, monitors (704) system messages to detect a cell identifier, such as a cell ID (CELL ID), an E-UTRAN Cell ID (ECI), or an E-UTRAN Cell Global Identifier (ECGI), and an eMBMS service area ID, and more particularly an MBSFN-AreaID. For example, the MBSFN-AreaID may be transmitted periodically over a 3GPP layer 2 System Information Block (SIB) and monitored by the UE. For instance, an eNodeB periodically may send the MBSFN-AreaID for the eMBMS service area in a System Information Block (SIB) 13 of a system information (SI) message.

Based on the detected cell information, UE 142 determines (706) whether a cell change has occurred, that is, whether the UE is in the coverage area of a new cell (as opposed to an old cell). When the UE detects that it is in the coverage area of a new cell, and based on the detected MBSFN-AreaID or a failure to detect an MBSFN-AreaID, UE 142 determines (708) whether the UE is within coverage of MBMS, and in particular within coverage of an MBSFN, and further determines (714) whether the UE has changed MBSFN Areas, that is, whether the UE has detected a new, as opposed to a previously detected (by the UE), MBSFN-AreaID.

In response to determining (708) that the UE is not within coverage of MBMS, that is, in response to a failure to detect an MBSFN-AreaID in association with the new cell, the UE further determines (710), by reference to its at least one memory device 204, whether the cell currently serving the UE supports MBMS, that is, whether the UE maintains an MBSFN-AreaID in association with the old cell. If neither the new cell nor the old cell supports MBMS, then logic flow diagram 700 ends (718). If the new cell does not support MBMS but the old cell does support MBMS, then the UE performs (712) an eMBMS service area update with Group Application Server 102, indicating, to the server, that the UE has moved to a new cell that does not support MBMS (for example, a “NULL” area), for example, by reporting that MBSFN AreaID=NULL or by reporting a “NULL MBSFN” using a known value or bit sequence to inform that the UE is no longer reachable via MBMS.

In response to determining (708) that the UE is within coverage of MBMS in the new cell, but that the UE has not changed (714) eMBMS service areas, there is no need for the UE to report the MBSFN-AreaID and logic flow diagram 700 ends (718). However, in response to determining (708) that the UE is within coverage of MBMS in the new cell and that the UE has changed (714), in the new cell, to a new eMBMS service area, UE 142 performs (716) an eMBMS service area update to identify its new eMBMS service area to Group Application Server 102, and logic flow diagram 700 then ends (718). More particularly, the UE transmits an eMBMS area identifier, and more particularly an MBSFN-AreaID plus additional eMBMS area information as described in greater detail below, to Group Application Server 102 in a MBSFN Area update message, for example, an MBSFN-AreaID Update message, which can take any suitable form depending on the protocols used in the communication system. For example, UE 142 may include the MBSFN Area update message in a SIP message, such as a SIP PUBLISH message. The eMBMS area identifier uniquely identifies, throughout a Public Land Mobile Network (PLMN), a specific MBSFN Area serving the UE. Preferably, a UE, such as UE 142, would not send the MBSFN Area update message upon every cell handover, but rather would send the message only upon detecting a change in MBSFN-AreaID coverage.

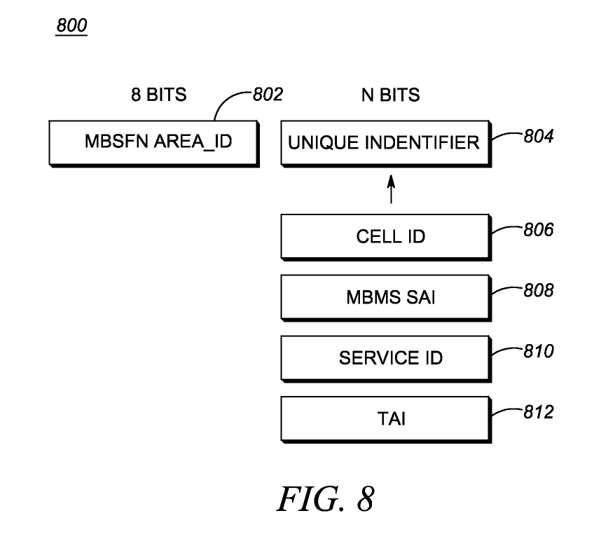

Referring now to FIG. 8, an exemplary eMBMS area identifier 800 is illustrated in accordance with various embodiments of the present invention. The eMBMS area identifier 800 includes a first data field 802 that includes an MBSFN-AreaID as known in the art. Further, in order to expand the number of unique eMBMS area identifiers beyond that available from mere use of MBSFN-AreaID and provide an eMBMS area identifier that uniquely identifies, throughout a PLMN, for example, throughout a national PLMN such as the nationwide public safety broadband network (NPSBN) defined by FirstNet, a specific MBSFN Area serving a UE, eMBMS area identifier 800 is an ‘extended’ area identifier that includes an extension to, or an additional data field that is read in conjunction with, the MBSFN-AreaID.

That is, eMBMS area identifier 800 includes an ‘extension identifier (ID)’ comprising an extension to first data field 802 or one or more second data fields 804, which extension/one or more second data fields comprises values derived from one or more of: one or more identifiers of a cell 806 where the UE is located, for example, one or more of an eNodeB identifier, a cell ID (CELL ID), an E-UTRAN Cell ID (ECI), or an E-UTRAN Cell Global Identifier (ECGI), a Mobile Country Code (MCC), and a Mobile Network Code (MNC) (preferably, if using an MCC, then also using an MNC); an identifier of a group of cells 808 within a PLMN, such as a MBMS service area identifier (SAI) (a 16 bit identifier that uniquely identifies a group of cells within a PLMN), a service identifier 810 associated with an MBMS bearer service to which the UE has subscribed, such as a Temporary Mobile Group Identity (TMGI); and a tracking, or paging, area identifier 812 associated with the cell where the UE is located, such as a Tracking Area Identifier (TAI), an MCC, and an MNC (again, preferably, at least an MNC if also using an MCC). Thus, by including one or more of a cell identifier, a MBMS service area identifier, a MBMS service identifier, and a tracking, or paging, area identifier, along with an MBSFN-AreaID, in an eMBMS area identifier, the MBSFN serving a UE shall be associated with a unique eMBMS area identifier, regardless of whether the MBSFN shares an MBSFN-AreaID with another MBSFN Area. The extension ID comprises values derived from the above one or more identifiers in the sense that the extension ID may include, for example, one or more of the identifiers themselves, concatenated versions of one or more of the identifiers, or values output by an algorithm whose input comprises one or more of the identifiers.

In another embodiment of the present invention, the eMBMS area identifier may only include the extension identifier. For example, suppose an MBMS SAI maps uniquely to one MBSFN Area (a 1:1 mapping). In such an instance, when an MBMS SAI is included in an MBSFN Area update message (for example, in the extension identifier field), then there is no need to also include an MBSFN-AreaID as the MBSFN-AreaID would merely be redundant of the MBMS SAI.

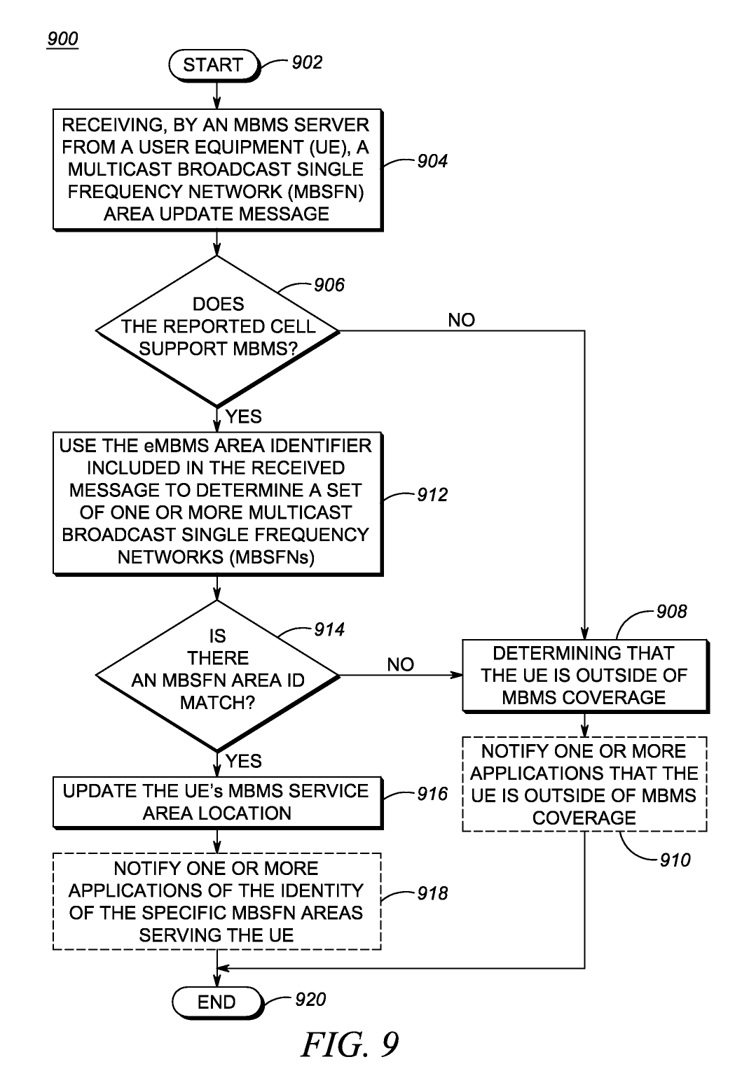

Referring now to FIG. 9, a logic flow diagram 900 is provided that illustrates a method performed by an MBMS-enabled application level infrastructure device, for example, Group Application Server 102, to update eMBMS Area Database 104 in response to receiving the eMBMS service area information from UE 142 in accordance with an embodiment of the present invention. Logic flow diagram 900 begins (902) when Group Application Server 102 receives (904) a MBSFN Area update message from UE 142. In response to receiving the MBSFN Area update message, Group Application Server 102 determines (906) whether the reported cell supports MBMS. If, at step 906, Group Application Server 102 determines MBSFN Area update message that the reported cell that does not support MBMS, Group Application Server 102 determines (908) that the UE is outside of the MBMS coverage of the Group Application Server. Group Application Server 102 then may notify (910) one or more applications that the UE is outside of MBMS coverage and is not eligible for MBMS services, and logic flow 900 then ends (920).

However, if, at step 906, Group Application Server 102 determines that the UE can receive messaging through MBMS, then the Group Application Server determines (912), based on the reported eMBMS area identifier, a set of one or more MBSFN Areas serving the UE, wherein each MBSFN Area in the set of MBSFN Areas is associated with an MBSFN-AreaID, and wherein each MBSFN Area's associated MBSFN-AreaID matches the MBSFN-AreaID included in the eMBMS area identifier.

In one embodiment of the present invention, the eMBMS area identifier included in the MBSFN Area update message may comprise a cell and/or eNodeB identifier (ID) and an MBSFN-AreaID. In such an instance, Group Application Server 102 can map the received cell/eNodeB ID to an MBMS SAI and then to one or more possible MBSFN Areas. The MBSFN-AreaID is then used to verify the specific MBSFN Area. This combination of cell/eNodeB ID and MBSFN-AreaID uniquely identifies the MBMS coverage area in which the UE is located. Thus from the combination of reported cell/eNodeB ID and MBSFN-AreaID, the UE's MBSFN Area can be reported unambiguously.

In another embodiment of the present invention, the eMBMS area identifier included in the MBSFN Area update message may comprise an MBMS SAI and MBSFN-AreaID. In this case, Group Application Server 102 may merely review a subset of table 600, that is, the MBMS SAI-to-MBSFN Area mapping. This combination uniquely identifies the eMBMS service area in which the UE is located. Thus, from the combination of reported MBMS SAI and MBSFN-AreaID, the UE's MBSFN Area can be reported unambiguously. However, typically, in standard 3GPP, the MBMS SAI is not provided to the UE. Therefore, in this embodiment, MBMS SAI information may be broadcast to UEs, for example, via an application-defined MBMS announcement channel or by other MBMS announcement procedures or configuration messaging. In still other embodiments of the present invention, other out-of-band mechansims could be used to configure a UE with a mapping of MBMS SAIs-to-MBSFNs, or the entirety of table 600.

In yet another embodiment of the present invention, the eMBMS Area identifier included in the MBSFN Area update message may comprise a Tracking Area Code (TAC) from a SIB-1 of a system information message rather than a cell identifier such as a Cell ID, an ECI, or an ECGI. The TAC is contained within SIB-1 and uniquely identifies a paging geography within a PLMN. This may be advantageous for cases where tracking areas and MBSFNs are aligned or for cases in which the combination of TAI and MBSFN guarantees uniqueness within a PLMN-ID. In such an instance, eMBMS Area Database 104 would be configured with a mapping between tracking area identifiers and MBSFN-AreaIDs.

In still another embodiment of the present invention, wherein RAN-specific MBMS configuration/provisioning may not be made available to Group Application Server 102, the Group Application Server may use a TMGI reported in combination with MBSFN Area update message. The TMGI is a PLMN unique identifier and could be used by the Group Application Server to identify the MBMS coverage area. The TMGI could be used as an extension identifier in the eMBMS area identifier to identify a specific MBSFN Area.

In response to determining the set of one or more MBSFNs serving the UE, Group Application Server 102 compares (914) the eMBMS area identifier to extended MBSFN identifiers maintained by eMBMS Area Database 104, for example, in table 600, to determine if there is a match. For example, in one such embodiment of the present invention, Group Application Server 102 may determine a set of MBSFN Areas based on the evolved Multimedia Broadcast/Multicast Service (eMBMS) area identifier, wherein each MBSFN Area in the set of MBSFN Areas is associated with an MBSFN-AreaID and select an MBSFN Area of the set of MSBFN Areas that corresponds to the extension identifier included in the eMBMS area identifier. In another such embodiment of the present invention, Group Application Server 102 may identify a set of MBSFN Areas based on the extension identifier included in the eMBMS area identifier and select an MBSFN Area of the set of MSBFN Areas based on the MBSFN-AreaID included in the eMBMS area identifier.

For example, and referring to table 600, Group Application Server 102 may compare the extension information included in the eMBMS area identifier to table 600 to see if the eMBMS area identifier matches a Cell ID, and/or SAI, and MBSFN-AreaID combination depicted in table 600. If the eMBMS area identifier included in the MBSFN Area update message does not match (914) any of the eMBMS area identifiers maintained by eMBMS Area Database 104, Group Application Server 102 determines (908) that the UE is outside of the MBMS coverage of the Group Application Server and may notify (910) one or more applications that the UE is outside of MBMS coverage and is not eligible for MBMS services. Logic flow 900 then ends (920).

If the eMBMS area identifier included in the MBSFN Area update message matches (914) an eMBMS area identifiers maintained by eMBMS Area Database 104, Group Application Server 102 updates (916) the UE's eMBMS service area by storing the received information in eMBMS Area Database 104, and if necessary deleting any stale or outdated eMBMS area information for UE 142. Group Application Server 102 then can use this information to identify the specific MBSFN Areas to include for media distribution to the UE. Group Application Server further may notify (918) one or more applications of the identity of the specific MBSFN Areas serving the UE. Logic flow 900 then ends (920).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for providing evolved Multimedia Broadcast/Multicast Service (eMBMS) area information in a Multimedia Broadcast/Multicast Service (MBMS) communication system, the method comprising:
receiving a Multicast Broadcast Single Frequency Network (MBSFN) Area update message from a user equipment, wherein the MBSFN Area update message includes an eMBMS area identifier that uniquely identifies an MBSFN Area and comprises an extension identifier derived from one or more of a cell identifier, an eNodeB identifier, an identifier of a group of cells, a service identifier, a tracking area identifier, and a paging area identifier; and
determining an MBSFN Area serving the user equipment based on the received eMBMS area identifier.

2. The method of claim A, wherein the eMBMS area identifier further comprises an MBSFN AreaID.

3. The method of claim 1, wherein the evolved Multimedia Broadcast/Multicast Service area identifier can be used to determine a unique Multicast Broadcast Single Frequency Network Area throughout a PLMN.

4. The method of claim 1, wherein the extension identifier includes a cell identifier comprising one or more of a Cell Identifier (CELL ID), an E-UTRAN Cell ID (ECI), an E-UTRAN Cell Global Identifier (ECGI), a Mobile Country Code (MCC), and a Mobile Network Code (MNC).

5. The method of claim 1, wherein the extension identifier is derived from a MBMS service area identifier (SAI).

6. The method of claim 1, wherein the extension identifier is derived from a service identifier associated with a Multimedia Broadcast/Multicast Service bearer service identified with a Temporary Mobile Group Identifier.

7. The method of claim 1, wherein the extension identifier is derived from one or more of a tracking area identifier and a paging area identifier and wherein the tracking area identifier comprises one or more of a Tracking Area Identifier (TAI), a Mobile Country Code (MCC), and a Mobile Network Code (MNC).

8. The method of claim 1, wherein determining a Multicast Broadcast Single Frequency Network Area serving the user equipment comprises:
determining that a reported area does not support Multimedia Broadcast/Multicast Service (MBMS) and that the user equipment is outside of MBMS coverage; and
notifying one or more applications that the user equipment is outside of MBMS coverage.

9. The method of claim 1, wherein determining a Multicast Broadcast Single Frequency Network (MBSFN) Area serving the user equipment comprises:
determining a set of MBSFN Areas based on the evolved Multimedia Broadcast/Multicast Service (eMBMS) area identifier, wherein each MBSFN Area in the set of MBSFN Areas is associated with an MBSFN-AreaID; and
selecting an MBSFN Area of the set of MSBFN Areas that corresponds to the extension identifier included in the eMBMS area identifier.

10. The method of claim 1, wherein determining a Multicast Broadcast Single Frequency Network (MBSFN) Area serving the user equipment comprises:
identifying a set of MBSFN Areas based on the extension identifier included in the eMBMS area identifier; and
selecting an MBSFN Area of the set of MSBFN Areas based on the MBSFN-AreaID included in the eMBMS area identifier.

11. The method of claim 1, further comprising updating an evolved Multimedia Broadcast/Multicast Service Area Database based on the determined Multicast Broadcast Single Frequency Network Area serving the user equipment.

12. The method of claim 1, further comprising notifying one or more applications of the determined Multicast Broadcast Single Frequency Network Area serving the user equipment.

13. A method for providing evolved Multimedia Broadcast/Multicast Service (eMBMS) area information in a Multimedia Broadcast/Multicast Service (MBMS) communication system, the method comprising:
detecting, by a user equipment, a cell change from an old cell to a new cell;
determining, by the a user equipment, whether the old cell supports MBMS and whether the new cell supports MBMS;
in response to determining that the new cell supports MBMS, determining whether the new cell is associated with a different MBSFN-AreaID than an MBSFN-AreaID associated with the old cell; and
when the new cell is associated with a different MBSFN-AreaID than an MBSFN-AreaID associated with the old cell, sending a MBSFN Area update message that includes an eMBMS area identifier comprising a MBSFN-AreaID and an extension identifier derived from one or more of a cell identifier, an eNodeB identifier, an identifier of a group of cells, a service identifier, a tracking area identifier, and a paging area identifier.

14. The method of claim 13, further comprising, when the new cell does not support MBMS and the old cell does support MBMS, performing an eMBMS service area update that indicates that the new cell does not support MBMS.

15. An evolved Multimedia Broadcast/Multicast Service (eMBMS)-enabled infrastructure device comprising:
a processor that is configured to:
receive an Multicast Broadcast Single Frequency Network (MBSFN) Area update message from a user equipment, wherein the MBSFN Area update message includes an eMBMS area identifier that uniquely identifies an MBSFN Area and comprises an extension identifier derived from one or more of a cell identifier, an eNodeB identifier, an identifier of a group of cells, a service identifier, a tracking area identifier, and a paging area identifier; and
determine an MBSFN Area serving the user equipment based on the received eMBMS area identifier.

16. The evolved Multimedia Broadcast/Multicast Service (eMBMS)-enabled infrastructure device of claim 15, wherein the eMBMS area identifier further comprises an MBSFN AreaID.

17. The evolved Multimedia Broadcast/Multicast Service (eMBMS)-enabled infrastructure device of claim 15, wherein the Multimedia Broadcast/Multicast Service location identifier can be used to determine a unique Multicast Broadcast Single Frequency Network Area throughout a PLMN.

18. The evolved Multimedia Broadcast/Multicast Service (eMBMS)-enabled infrastructure device of claim 15, wherein the extension identifier includes a cell identifier comprising one or more of a Cell Identifier (CELL ID), an E-UTRAN Cell ID (ECI), an E-UTRAN Cell Global Identifier (ECGI), a Mobile Country Code (MCC), and a Mobile Network Code (MNC).

19. The evolved Multimedia Broadcast/Multicast Service (eMBMS)-enabled infrastructure device of claim 15, wherein the extension identifier is derived from an MBMS service area identifier (SAI).

20. The evolved Multimedia Broadcast/Multicast Service (eMBMS)-enabled infrastructure device of claim 15, wherein the extension identifier is derived from a service identifier associated with a Multimedia Broadcast/Multicast Service bearer service identified with a Temporary Mobile Group Identifier.

21. The evolved Multimedia Broadcast/Multicast Service (eMBMS)-enabled infrastructure device of claim 15, wherein the extension identifier is derived from one or more of a tracking area identifier and a paging area identifier and wherein the tracking area identifier comprises one or more of a Tracking Area Identifier (TAI), a Mobile Country Code (MCC), and a Mobile Network Code (MNC).

22. The evolved Multimedia Broadcast/Multicast Service (eMBMS)-enabled infrastructure device of claim 15, wherein the processor is configured to determine a Multicast Broadcast Single Frequency Network Area serving the user equipment by:
determining that a reported area does not support Multimedia Broadcast/Multicast Service (MBMS) and that the user equipment is outside of MBMS coverage; and
notifying one or more applications that the user equipment is outside of MBMS coverage.

23. The evolved Multimedia Broadcast/Multicast Service (eMBMS)-enabled infrastructure device of claim 15, wherein the processor is configured to determine a Multicast Broadcast Single Frequency Network (MBSFN) Area serving the user equipment by:
determining a set of MBSFN Areas based on the evolved Multimedia Broadcast/Multicast Service (eMBMS) area identifier, wherein each MBSFN Area in the set of MBSFN Areas is associated with an MBSFN-AreaID; and
selecting an MBSFN Area of the set of MSBFN Areas that corresponds to the extension identifier included in the eMBMS area identifier.

24. The evolved Multimedia Broadcast/Multicast Service (eMBMS)-enabled infrastructure device of claim 15, wherein the processor is configured to determine a Multicast Broadcast Single Frequency Network (MBSFN) Area serving the user equipment by:
identifying a set of MBSFN Areas based on the extension identifier included in the eMBMS area identifier; and
selecting an MBSFN Area of the set of MSBFN Areas based on the MBSFN-AreaID included in the eMBMS area identifier.

25. The evolved Multimedia Broadcast/Multicast Service (eMBMS)-enabled infrastructure device of claim 15, wherein the processor further is configured to update a Multimedia Broadcast/Multicast Service location database based on the determined Multicast Broadcast Single Frequency Network Area serving the user equipment.

26. The evolved Multimedia Broadcast/Multicast Service (eMBMS)-enabled infrastructure device of claim 15, wherein the processor further is configured to notify one or more applications of the determined Multicast Broadcast Single Frequency Network Area serving the user equipment.

27. An evolved Multimedia Broadcast/Multicast Service (eMBMS)-enabled user equipment comprising:
a processor that is configured to:
detect a cell change from an old cell to a new cell;
determine whether the old cell supports MBMS and whether the new cell supports MBMS;
in response to determining that the new cell supports MBMS, determine whether the new cell is associated with a different MBSFN-AreaID than an MBSFN-AreaID associated with the old cell; and
when the new cell is associated with a different MBSFN-AreaID than an MBSFN-AreaID associated with the old cell, send an MBSFN Area update that includes an eMBMS area identifier comprising a MBSFN-AreaID and an extension identifier derived from one or more of a cell identifier, an eNodeB identifier, an identifier of a group of cells, a service identifier, a tracking area identifier, and a paging area identifier.

28. The Multimedia Broadcast/Multicast Service (MBMS)-enabled user equipment of claim 27, wherein the processor further is configured to, when the new cell does not support MBMS and the old cell does support MBMS, perform an eMBMS service area update that indicates that the new cell does not support MBMS.
